(19) United States
(12) Patent Application Publication
(10) Pub. No.: US 2021/0094399 A1
(43) Pub. Date: Apr. 1, 2021

(54) Self-Inflating Vehicle Protector

(71) Applicant: Carlos Sanchez, San Antonio, TX (US)

(72) Inventor: Carlos Sanchez, San Antonio, TX (US)

(21) Appl. No.: 16/933,775

(22) Filed: Jul. 20, 2020

Related U.S. Application Data
(60) Provisional application No. 62/908,148, filed on Sep. 30, 2019.

(51) Int. Cl. B60J 11/04

(52) U.S. Cl. CPC B60J 11/04

(57) ABSTRACT

A self-inflating vehicle protector is provided. The self-inflating vehicle protector includes a plurality of pads including an upper pad and a pair of side pads. Each of the plurality of pads includes an upper layer and a lower layer defining an interior volume therebetween. A compressible material is disposed within the interior volume. A fastener is disposed on opposing lateral sides of the upper pad, wherein the fastener removably secures to a complementary fastener disposed along an upper edge of each of the pair of side pads. A nozzle is disposed on each of the plurality of pads, wherein the nozzle provides access to the interior volume. The compressible material is biased to an expanded position and moves to a compressed position when air is removed from the interior volume via the nozzle.

### CROSS REFERENCE TO RELATED APPLICATIONS

This application claims the benefit of U.S. Provisional Application No. 62/908,148 filed on Sep. 30, 2019. The above identified patent application is herein incorporated by reference in its entirety to provide continuity of disclosure.

### BACKGROUND OF THE INVENTION

The present invention relates to vehicle protectors. More particularly, the present invention pertains to a self-inflating vehicle protector configured to automatically deploy to an expanded position when a nozzle is opened.

Many individuals park their vehicles outdoors, such as in driveways, public parking lots, on the street, or in other such locations exposed to the environment. Typically, these vehicles are left uncovered leaving the vehicle susceptible to damage, whether from other individuals or environmental effects such as weather. Over an extended period, a parked vehicle can suffer significant damage, including dents, scratches, and the like from inclement weather such as hail, ice, or debris being carried by heavy winds. Such vehicle damage can be costly to repair. Existing vehicle covers may help to mitigate such damage, however typical vehicle covers can be bulky, difficult to transport, and frustrating to secure to the vehicle. This can be especially problematic when attempting to hastily apply the vehicle cover to a vehicle in light of a fast-moving storm. Additionally, typical vehicle covers offer limited padding to prevent damage from impacts over the body of the vehicle, such as from ice, hail, or other debris common in severe storms.

In light of the devices disclosed in the known art, it is submitted that the present invention substantially diverges in design elements from the known art and consequently it is clear that there is a need in the art for an improvement to existing vehicle protectors. In this regard, the instant invention substantially fulfills these needs.

### SUMMARY OF THE INVENTION

In view of the foregoing disadvantages inherent in the known types of vehicle protectors now present in the known art, the present invention provides a self-inflating vehicle protector wherein the same can be utilized for providing convenience for the user when protecting their vehicle from impact damage without requiring additional equipment to inflate the protector.

The present system comprises a plurality of pads including an upper pad and a pair of side pads, wherein each of the plurality of pads comprises an upper layer and a lower layer defining an interior volume therebetween. A compressible material is disposed within the interior volume. A fastener is disposed on opposing lateral sides of the upper pad, wherein the fastener is configured to removably secure to a complementary fastener disposed along an upper edge of each of the pair of side pads. A nozzle is disposed on each of the plurality of pads, wherein the nozzle provides access to the interior volume, wherein the compressible material moves to a compressed position when air is removed from the interior volume via the nozzle. In some embodiments, the upper pad comprises a plurality of sections, including a front section, a central section, and a rear section, wherein each of the plurality of sections are separated by a seam, such that the interior volume of each of the plurality of sections is isolated.

In another embodiment, a plurality of straps is affixed to a lower surface of the upper pad. In some such embodiments, the plurality of straps each comprise a hook on a distal end thereof, wherein other embodiments, the plurality of straps each comprise a first section removably securable to a second section. In other embodiments, a pocket is disposed on each of the pair of side pads, wherein the pocket is configured to receive a side mirror of a vehicle therein. In another embodiment, the pair of side pads are mirrored relative to each other. In some embodiments, the pair of side pads includes an arcuate forward projection configured to contour to a forward portion of a vehicle. In other embodiments, a front end and a rear end of the upper pad curve in a direction opposite from the upper layer to contour to a front portion and a rear portion of a vehicle, respectively. In another embodiment, the nozzle is disposed on an exterior edge of the plurality of pads.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of an embodiment of the self-inflating vehicle protector.

FIG. 2 shows a perspective view of the upper pad of an embodiment of the self-inflating vehicle protector.

FIG. 3 shows a cross-sectional view of an embodiment of the self-inflating vehicle protector.

FIG. 4 shows a perspective view of an embodiment of the self-inflating vehicle protector affixed to a vehicle.

### DETAILED DESCRIPTION OF THE INVENTION

Reference is made herein to the attached drawings. Like reference numerals are used throughout the drawings to depict like or similar elements of the self-inflating vehicle protector. The figures are intended for representative purposes only and should not be considered to be limiting in any respect.

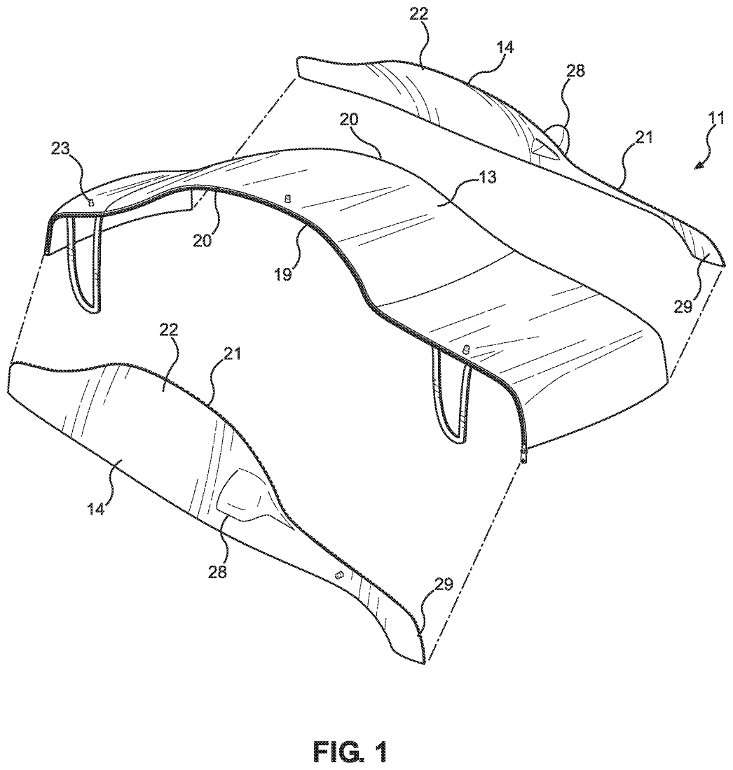

Referring now to FIG. 1, there is shown an exploded view of an embodiment of the self-inflating vehicle protector. The self-inflating vehicle protector 11 comprises a plurality of pads, including an upper pad 13 removably securable to a pair of side pads 14. When secured together, the upper pad 13 and the pair of side pads 14 are dimensioned to encompass an exterior surface of a vehicle, thereby protecting the vehicle from impact damage. Each of the plurality of pads include an upper layer (as shown in FIG. 3, 15) and a lower layer (as shown in FIG. 3,16), wherein the upper and lower layers define an interior volume (as shown in FIG. 3, 18) therebetween. The interior volume includes a compressible material therein, wherein the compressible material is configured to attenuate and distribute impact forces across an entirety of the plurality of pads, thereby reducing damage to the underlying vehicle.

At least one nozzle 23 is disposed on each of the plurality of pads, wherein the nozzle 23 provides access to the interior volume. In this manner, the user can remove air from the interior volume, thereby moving the compressible material to a compressed position. In some embodiments, the nozzle 23 is dimensioned to removably secure a standard vacuum cleaner hose thereon, such that a user can remove air with an existing vacuum cleaner. Alternatively, the nozzle 23 can be opened, allowing the user to roll and compress the plurality of pads to manually compress the compressible material, removing the air therefrom. In some embodiments, the nozzle 23 comprises a one-way valve, allowing air to be removed from the interior volume, but remaining in a closed state to prevent air from reentering the interior volume. In alternate embodiments, the nozzle 23 further comprises a cap removably securable thereto, the cap configured to prevent air from reentering the interior volume. In either case, the user can selectively open the nozzle 23 to allow the compressible material within the interior volume to move to an expanded position when air is reintroduced, thereby increasing the impact force attenuation properties thereof.

In the shown embodiment, the upper pad 13 is removably securable to the pair of side pads 14 via a fastener 19 disposed on opposing lateral sides 20 of the upper pad 13. The fastener 19 is removably securable to a complementary fastener 21 disposed along an upper edge 22 of each of the pair of side pads 14. In this manner, the upper pad 13 and the pair of side pads 14 can be secured together over a vehicle to prevent damage thereto. In the shown embodiment, the fastener 19 and the complementary fastener 21 comprise zippers, however, in alternate embodiments, alternate fastening means are contemplated, such as but not limited to, snaps, buttons, clasps, and the like.

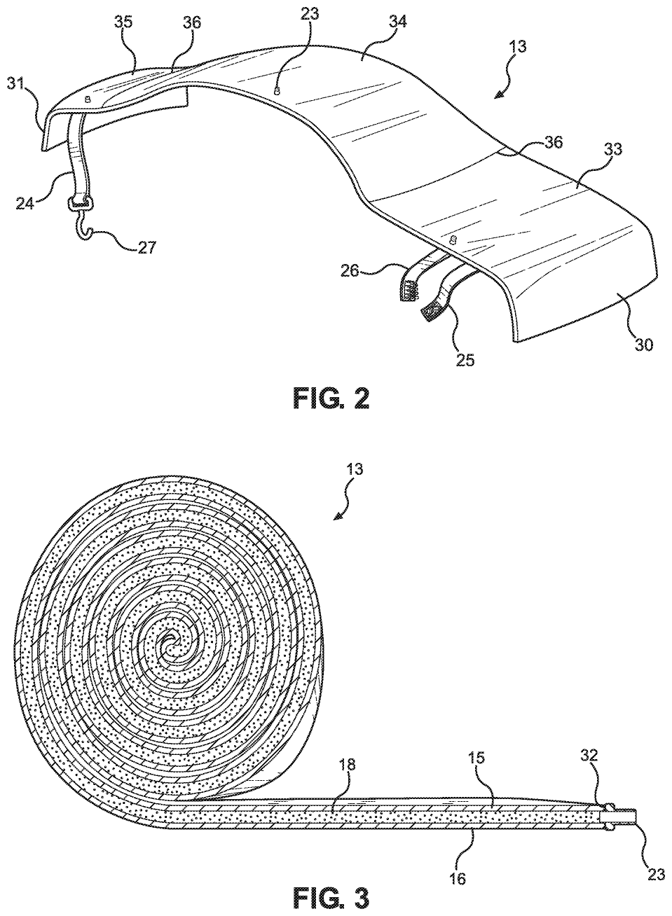

In the illustrated embodiment, the pair of side pads 14 are mirrored relative to each other, such that the pair of side pads 14 are configured to conform to the sides of a vehicle. In the shown embodiment, the pair of side pads 14 further comprise a pocket 28 thereon, wherein the pocket 28 is configured to receive a side mirror of the vehicle therein. In this manner, the pair of side pads 14 can more accurately contour to the dimensions of a vehicle. Furthermore, in the shown embodiment, the pair of side pads 14 further comprise an arcuate forward projection 29, wherein the arcuate forward projection 29 is configured to contour around a wheelbase of the vehicle and cover the forward quarter panel of the vehicle. In this manner, the wheels of the vehicle are exposed, allowing the plurality of straps (shown in FIG. 2, 24) to secure to the vehicle wheel. The pair of side pads 14 are dimensioned to extend along a majority of the vehicle sides to prevent damage thereto. In various embodiments, the pair of side pads 14 are contemplated to extend downward along an entirety of the vehicle sides, such that the self-inflating vehicle protector 11 covers an entirety thereof.

Referring now to FIG. 2, there is shown a perspective view of the upper pad of an embodiment of the self-inflating vehicle protector. In the shown embodiment, the upper pad 13 comprises a plurality of sections including a front section 33, a central section 34, and a rear section 35, wherein each of the plurality of sections are separated by a seam 36. The seam 36 isolates an interior volume of each of the plurality of sections, such that a user can separately inflate each independent section. The seam 36 further provides additional flexibility to the upper pad 13, thereby allowing the upper pad 13 to contour to a variety of vehicles more accurately. In the shown embodiment, each section of the plurality of sections includes a nozzle 23 thereon, such that a user can independently inflate or compress each section as desired. In the shown embodiment, the front section 33 further comprises a front end 30 curving downwards in a direction opposite to the upper layer, such that the front end 30 can protect a grille of the vehicle. Similarly, in the illustrated embodiment, the rear section 35 further comprises a rear end 31 curving downwards away from the upper layer to extend along a rear end and trunk of the vehicle to provide additional protection thereto.

In the shown embodiment, a plurality of straps 24 are disposed on a lower surface of the upper pad 13 adjacent to the opposing lateral sides thereof. In the shown embodiment, the plurality of straps 24 comprise four separate straps 24, each configured to removably secure to a wheel of the vehicle, however alternate embodiments with greater or fewer numbers of straps 24 are contemplated, such as for vehicles with differing numbers of wheels, or straps 24 placed on opposing corners of the upper pad 13. In such an embodiment, the plurality of straps 24 would removably secure to a front wheel and an opposite rear wheel, for example a front driver's side wheel and a rear passenger's side wheel. The plurality of straps 24 are configured to removably secure about spokes of the wheel of the vehicle. The plurality of straps 24 can comprise a hook 27 disposed on a distal end of the strap 24, wherein the hook 27 is configured to removably secure about a spoke of wheel. In some such embodiments, the hook 27 further comprises a rubber or other cushioned coating thereon configured to prevent damage to the wheel. Alternatively, the plurality of straps 24 comprise a first section 25 removably securable to a second section 26, wherein the first and second sections 25, 26 can be inserted through a wheel about a spoke thereof and secured to each other via a fastener to secure the upper pad 13 to the vehicle. In the shown embodiment, the strap fastener comprises a hook and loop fastener, however alternate fastening means are contemplated. In the shown embodiment, various styles of straps 24 are shown simultaneously disposed on the upper pad 13 for illustrative purposes, however each of the plurality of straps 24 are additionally contemplated to comprise a uniform style.

Referring now to FIG. 3, there is shown a cross-sectional view of an embodiment of the self-inflating vehicle protector. The upper pad 13 comprises an upper layer 15 disposed opposite a lower layer 16, wherein the upper and lower layers 15, 16 define an interior volume 18 therebetween. The upper and lower layers 15, 16 comprise an impermeable, tear-resistant, and durable material to ensure that the interior volume 18 remains airtight to allow the user to compress the interior volume 18 for storage or transport via the nozzle 23. In some embodiments, the upper and lower layers 15, 16 comprise a durable and tear-resistant plastic or fabric material. The interior volume 18 further comprises a compressible material therein, wherein the compressible material is configured to selectively move between an expanded position and a compressed position. The compressible material can comprise an air permeable sponge-like material, wherein the volume of the compressible material is increased when air permeates the compressible material. In this manner, air pockets formed within the compressible material serve to insulate the vehicle from impact damage. For example, when an object strikes the upper pad 13, the force of the impact causes a localized compression of the compressible material, which is then dispersed across the entirety of the upper pad 13.

In the shown embodiment, the upper pad 13 can be rolled when the compressible material is in a compressed position, such that the upper pad 13 comprises a minimal form factor for ease of transport and storage. In the illustrated embodiment, the nozzle 23 is disposed on an exterior edge 32 of the upper pad 13, such that the nozzle 23 does not impede rolling thereof. Similarly, the position of the nozzle 23 on the pair of side pads can be placed along an edge thereof to aid in storage and rolling thereof.

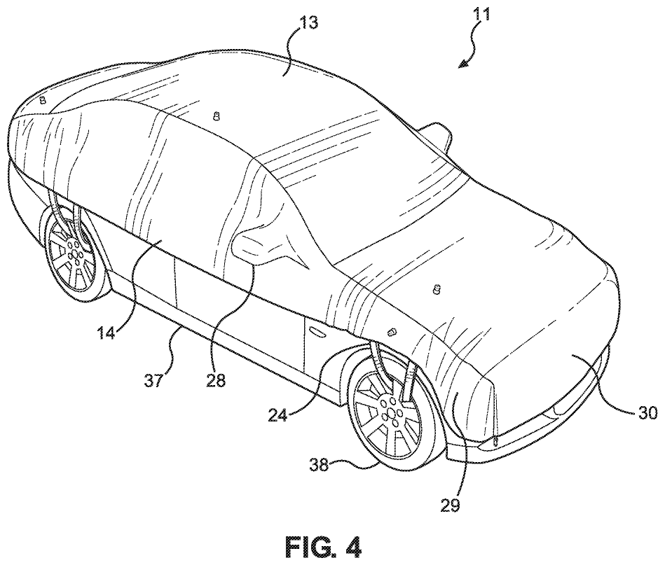

Referring now to FIG. 4, there is shown a perspective view of an embodiment of the self-inflating vehicle protector affixed to a vehicle. In one use, the self-inflating vehicle protector 11 can be removably secured to a vehicle 37 quickly and efficiently. In some embodiments, the self-inflating vehicle protector 11 is dimensioned specifically for a desired make and model of vehicle 37, however, in alternate embodiments, the self-inflating vehicle protector 11 comprises a generalized shape to conform to a variety of different vehicles 37. The upper pad 13 can be unrolled from a storage position (as shown in FIG. 3) and placed over the upper portion of the vehicle 37. The plurality of straps 24 can then be secured to the vehicle wheels 38, thereby securing the upper pad 13 to the vehicle 37. The pair of side pads 14 can then be secured along opposing lateral sides of the upper pad 13 via the fastener and complementary fastener. When securing the pair of side pads 14 to the vehicle 38, the side mirrors of the vehicle can be placed within the pockets 28 of the pair of side pads 14, such that the side mirrors are similarly protected from impact damage as the remainder of the vehicle 37. In the shown embodiment, the front end 30 of the upper pad 13 curves downward such that the front end 30 extends over the grille of the vehicle 37. Similarly, the rear end extends downwardly over the rear of the vehicle 37. The arcuate forward projection 29 of the pair of side pads 14 extends over the front quarter panel of the vehicle 37 while leaving the wheels 38 exposed to allow the user to secure the plurality of straps 24 thereto. The user can then open the plurality of nozzles to allow air to expand the compressible material to provide additional padding and impact protection to the vehicle 37.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A self-inflating vehicle protector, comprising:
a plurality of pads including an upper pad and a pair of side pads;
wherein each of the plurality of pads comprises an upper layer and a lower layer defining an interior volume therebetween;
wherein a compressible material is disposed within the interior volume;
a fastener disposed on opposing lateral sides of the upper pad;
wherein the fastener is configured to removably secure to a complementary fastener disposed along an upper edge of each of the pair of side pads;
a nozzle disposed on each of the plurality of pads, wherein the nozzle provides access to the interior volume;
wherein the compressible material moves to a compressed position when air is removed from the interior volume via the nozzle.

2. The self-inflating vehicle protector of claim 1, further comprising a plurality of straps affixed to a lower surface of the upper pad.

3. The self-inflating vehicle protector of claim 2, wherein each of the plurality of straps comprises a hook on a distal end thereof.

4. The self-inflating vehicle protector of claim 2, wherein each of the plurality of straps comprise a first section removably securable to a second section.

5. The self-inflating vehicle protector of claim 1, further comprising a pocket on each of the pair of side pads, wherein the pocket is dimensioned receive a side mirror of a vehicle therein.

6. The self-inflating vehicle protector of claim 1, wherein the pair of side pads are mirrored relative to each other.

7. The self-inflating vehicle protector of claim 1, wherein the pair of side pads include an arcuate forward projection dimensioned to contour to a forward portion of a vehicle.

8. The self-inflating vehicle protector of claim 1, wherein a front end and a rear end of the upper pad curve downwardly in a direction opposite to the upper layer to contour to a front portion and a rear portion of a vehicle, respectively.

9. The self-inflating vehicle protector of claim 1, wherein the nozzle is disposed on an exterior edge of the plurality of pads.

10. A self-inflating vehicle protector, comprising:
a plurality of pads including an upper pad and a pair of side pads;
wherein each of the plurality of pads comprises an upper layer and a lower layer defining an interior volume therebetween;
wherein a compressible material is disposed within the interior volume;
wherein the upper pad defines a plurality of sections including a front section, a central section, and a rear section;
wherein each of the plurality of sections are separated by a seam such that a corresponding interior volume of each of the plurality of sections is isolated;
a fastener disposed on opposing lateral sides of the upper pad;
wherein the fastener is configured to removably secure to a complementary fastener disposed along an upper edge of each of the pair of side pads;
a nozzle disposed on each of the plurality of pads, wherein the nozzle provides access to the interior volume;
wherein the compressible material moves to a compressed position when air is removed from the interior volume via the nozzle.

11. The self-inflating vehicle protector of claim 10, further comprising a plurality of straps affixed to a lower surface of the upper pad.

12. The self-inflating vehicle protector of claim 11, wherein each of the plurality of straps comprises a hook on a distal end thereof.

13. The self-inflating vehicle protector of claim 11, wherein each of the plurality of straps comprise a first section removably securable to a second section.

14. The self-inflating vehicle protector of claim 10, further comprising a pocket on each of the pair of side pads, wherein the pocket is dimensioned to receive a side mirror of a vehicle therein.

15. The self-inflating vehicle protector of claim 10, wherein the pair of side pads are mirrored relative to each other.

16. The self-inflating vehicle protector of claim 10, wherein the pair of side pads include an arcuate forward projection dimensioned to contour to a forward portion of a vehicle.

17. The self-inflating vehicle protector of claim 10, wherein a front end and a rear end of the upper pad curve downwardly in a direction opposite to the upper layer to contour to a front portion and a rear portion of a vehicle, respectively.

18. The self-inflating vehicle protector of claim 10, wherein the nozzle is disposed on an exterior edge of the plurality of pads.
